(19) United States
(12) Patent Application Publication
(10) Pub. No.: US 2026/0226362 A1
(43) Pub. Date: Aug. 6, 2026

(54) COMPOUND CATALYSTS FOR ENVIRONMENTALLY FRIENDLY COMBUSTION OF FUELS

(71) Applicants: Yury Viacheslavovich Bodrov, Saint-Petersburg (RU); Artur Vyacheslavovich Filippov, Saint-Petersburg (RU); David Perrin, Saint-Petersburg (RU); Alexander Petriovich Kuznetsov, Saint-Petersburg (RU)

(72) Inventors: Yury Viacheslavovich Bodrov, Saint-Petersburg (RU); Artur Vyacheslavovich Filippov, Saint-Petersburg (RU); David Perrin, Saint-Petersburg (RU); Alexander Petriovich Kuznetsov, Saint-Petersburg (RU)

(21) Appl. No.: 19/061,741

(22) Filed: Feb. 24, 2025

(51) Int. Cl. C10L 9/02; B01J 37/04; B01J 37/08

(52) U.S. Cl. CPC C10L 9/02; B01J 37/04; B01J 37/084; C10L 2230/22

(57) ABSTRACT

The present invention relates to a new class of coordination compound fuel combustion catalysts. This invention successfully solves the main problems described above particularly complex positive influence on all steps of combustion process. The solution is used to improve the energy efficiency of burning solid and liquid fuels to produce heat and electricity, in particular when burning low-grade fuels (i.e. biomass/coal dust), municipal solid waste (MSW) and fuels based on them (RDF) to produce heat and electricity.

### FIELD OF THE INVENTION

The invention relates to a compound catalysts for optimal combustion of solid and liquid fuels that increase the energy efficiency of the combustion process and reduce the number of harmful emissions into the environment, and more particularly to a process for the environmentally friendly combustion of liquid and solid fuels.

### DESCRIPTION OF THE BACKGROUND OF THE PRIOR ART

Combustion of different fuels, such as biofuels, refuse derived fuel (RDF), municipal waste, pellets, peat, brown and hard coal, heavy fuel oils and others, occupies a significant part of heat generation nowadays. Typically, fuels are characterized by low energy efficiency in particular when burning low-grade fuels (i.e. biomass/coal dust) and the release of a large number of harmful substances during combustion, being burned in nonoptimal conditions, what affects the environment negatively.

Improving the energy efficiency of fuel combustion is of great importance for protecting the environment. Increasing the energy efficiency of fuel combustion reduces their consumption. On the other hand, the quantity of harmful emissions is reduced as the fuel burns more completely and the side reactions of formation of harmful substances such as dioxins are suppressed. Catalysts for the combustion of solid fuels are widely known, which increase the efficiency of its combustion and reduce the level of harmful emissions.

In one of prior art references, it was examined combustion of coal and semicoke modified by 5 wt % of Cu(NO3)2, CuSO4 and Cu (CH3COO)2. The additives were introduced using the wet impregnation method. It was found that, on average, the use of activating additives contributed to a reduction of the ignition delay time by 1.8 times and a decrease in the minimum ignition temperature by 54-135° C. An increase in the heating medium temperature resulted in a significant ignition delay decrease (by ~270%). The maximum difference in the ignition delay time between the reference sample and the modified coal (3.4 s) and semicoke (10.4 s) samples was observed at 500° C. while using copper nitrate. In the initial stage of combustion, formation of micro-explosions on the samples modified with copper nitrate and acetate was observed. The use of additives contributed to reducing the content of unburnt carbon in the fuel. Addition of copper salts resulted in a significant reduction in the CO production volume and better fuel oxidation to CO2. Disadvantage of the proposed method is high concentration of the catalyst needed to achieve the desired effect.

Another prior art solution proposed adding CaO to semi-coke in concentration 2% by weight. It was found that the apparent activation energies of semi-coke during combustion reaction decreased with the increase in conversion. However, the additive works in high concentration that increase ach volume. Still another prior art reference disclosed a hard coal combustion catalyst which is mixture of inorganic salts including rare-earth salts. While the catalyst is relatively effective at low concentration, applying of rare-earths is expensive.

Still another prior art reference disclosed a hard coal combustion catalyst which includes relatively large number of rare-earth salts also the catalyst is expensive and applicable to hard coal only while other types of fuels such as RDF or liquid fuels aren't suitable for such approach.

As was disclosed in still another reference, it was proposed to apply NaNO3 and CuSO4 additive to coal for improving its combustion process. It was noted that added mineral salts led to a noticeable decrease in the coal's initial oxidation temperature and reaction acceleration at an early stage of the process. The disadvantage of the proposed approach is high catalyst concentration 5% that is needed to achieve the desired effect.

According to still another prior art reference, coal combustion catalysts were prepared from a mixture of inorganic alkaline earth salts (Mg, Ca, Sr, and Ba) and transitional metals salts (Mn, Fe, Ni, Cr, Zn, and Cu). The proposed catalysts were effective but at high concentration 2% by weight that is disadvantages of the proposed method.

It was also described rare-earth based catalyst that is effective for coal combustion. Disadvantage of the proposed catalyst is high concentration of rare-earth used. According to reference, Fe2O3, CaO, and MnO2 were proposed as catalysts for combustion of coal. But these catalysts are effective at high concentrations only and they increase ach content that is disadvantage of the method.

Finally, one of other prior art references described approach in which NaClO4 was used as a single catalyst and in other test it was used a composite catalyst, BaCO3:MnO2:ZnO:NaClO4 with 1:1:2:2 ratio. In both cases the ignition temperature and burnout temperature of the coal were decreased when catalyzed by the catalysts. However, the proposed approach disadvantage is high catalyst concentration 1 % by weight and it influence on burning stage only.

Therefore, there is a need to create a universal fuel combustion catalyst. This catalyst should not depend on the type of fuel. It will increase the combustion efficiency of both solid and liquid fuels. The catalyst must act at a low concentration and not affect the ash content in the final combustion products.

Existing analogs have a different chemical structure and act only at the fuel combustion stage. The low energy efficiency of fuels is determined by many factors, but the main one is the significant energy consumption for the decomposition of polymer compounds contained in the fuel itself. This fully applies to a wide variety of fuel types. In particular, when burning RDF, significant energy consumption is spent on the decomposition of polyolefins that are part of this type of fuel.

When biofuel is burned, energy is spent on breaking down the cellulose molecules that make up its composition. When burning low-calorie brown or hard coal, a significant amount of energy released is spent on the destruction of polymer molecules of lignin and lignin-like polymers included in its composition. This significantly reduces the calorific value of the fuels.

Another important factor is the variability of the calorific value of the same fuel. In particular, at waste incineration plants there is a problem of variability in the calorific value of the waste being burned, which, in some cases, leads to unstable operation of the boiler. Therefore, this problem requires a solution in the form of classification and sorting of waste, which leads to significant costs and reduces economic efficiency. This problem also manifests itself in the case of RDF, low-calorie coal and biofuels and also requires costs for classification, sorting and averaging of the same types of fuels with different calorific values.

An important indicator of fuels during combustion is the minimal formation of toxic substances, such as dioxins or polyaromatic hydrocarbons. These substances are extremely dangerous to human health and the environment. It is widely known that these and other toxic substances are formed in a certain temperature range and by a certain chemical mechanism from chemicals that are formed during the breakdown of fuel components during the combustion process. This is especially true when burning municipal waste at incineration plants, since this type of waste is quite diverse in composition and therefore precursors of toxic substances can be formed during the combustion process. Therefore, to prevent the formation of toxic substances, it is necessary to maintain optimal temperature and other parameters of the combustion process to ensure environmental safety.

Another important indicator of high-quality fuel is its ash content. Ash formation is caused by many factors, but the main ones are the content of non-combustible inorganic substances, such as metal particles, and incomplete combustion of fuel. Since the first problem can be solved solely through the separation of non-combustible substances from the bulk of the fuel, the process of complete combustion is ensured solely by the selection of optimal conditions for the combustion process.

This becomes important, for example, when burning low-calorie coal because coal dust often slips through the furnace and unburned coal particles enter the ash, which causes both significant economic damage due to high fuel consumption and environmental damage since ash is classified as toxic waste. Therefore, ensuring optimal fuel combustion conditions is extremely important.

The present invention aims to solve this problem by simple and convenient means.

### SUMMARY OF THE INVENTION

The present invention relates to a new class of coordination compound fuel combustion catalysts. This invention successfully solves the main problems described above particularly complex positive influence on all steps of combustion process. The solution is used to improve the energy efficiency of burning solid and liquid fuels to produce heat and electricity, in particular when burning low-grade fuels (i.e. biomass/coal dust), municipal solid waste (MSW) and fuels based on them (RDF) to produce heat and electricity. Currently, there are combustion catalysts of a different chemical nature that act only at the stage of fuel combustion, creating oxidation centers that promote more complete combustion of the fuel.

In this invention, it is proposed to use coordination compounds as catalysts for the combustion of solid and liquid fuels in accordance with the general formula: [C1aC2b . . . CmzL1 i L2 j . . . Lr1]A1a*ka/na A2b*kb/nb . . . Amz*kz/nz, where C1, C2, . . . Cm—cations particularly metal ions that form coordination compounds with various ligands; L1, L2, . . . Lr—any ligands, organic or inorganic, containing or not containing metals and having ability to form coordination bonds with cations; A1, A2, . . . Am—any anions, organic or inorganic, whether or not containing metals; Indices 1, 2, . . . m—serial number of various cations and anions; indexes 1, 2, . . . r—serial number of ligands; Index m may not be equal to index r; coefficients a, b, . . . Z are numerically equal to the number of atoms (or moles) of cations taken in relation to the corresponding number of molecules (or moles) of ligands and can be equal to any natural number; the coefficients i, j, . . . 1 are numerically equal to the number of moles of ligands taken in relation to the corresponding number of atoms (or moles) of cations and can be any natural number; the value of the number ka, kb, . . . kz is numerically equal to the charge of the cation, taken in the amount of a, b, . . . z; the value of the number na, nb, . . . nz is numerically equal to the charge of the anion corresponding to the cation, taken in the amount a, b, . . . z.

In the above general formula cations, ligands and anions quantity could be from 0 to infinite. Catalysts are capable increase the efficiency of fuel combustion processes at a low concentration of 0.000000001 to 5% by weight of the fuel, but preferably at concentrations from 0.001 to 0.1% by weight of the fuel. The fuel is treated by spraying with a catalyst solution, taken mainly in a concentration of 0.001-0.1% by weight relative to the fuel (a catalyst solution or a microencapsulated catalyst solution can be used, in which case the fuel is mixed with microcapsules).

Then the fuel is burned in the usual way. The catalyst affects the fuel at the heating stage and destroys the polymer structure of the fuel into smaller fragments, which are more easily oxidized by atmospheric oxygen. At the stage of fuel combustion, particles of catalyst decomposition products create catalytic oxidation centers, increasing the efficiency of the combustion process. At the same time, due to the two-stage action of the catalyst, a total increase in the energy efficiency of the fuel combustion process of up to 25% is ensured.

There are several advantageous effects of the proposed catalysts including and not limited to improving the energy efficiency of the fuel combustion process and increasing the calorific value of low-calorie fuel, in particular when burning low-grade fuels (i.e. biomass/coal dust), municipal solid waste (MSW) and fuels based on them (RDF) to produce heat and electricity and improving the uniformity of fuel combustion during the combustion process; reduction of harmful emissions; reduction of ash formation.

One of the most important effects of the use of catalysts in accordance with the present invention is the increase in energy efficiency of combustion of both solid and liquid fuels, in particular the introduction of catalysts in accordance with the present invention into both solid and liquid fuels at concentrations from 0.001 to 0.1% by weight of the fuel, promotes stable and complete combustion of fuels.

It also increases the calorific value of fuels by up to 25%, depending on the type of fuel. This occurs due to a catalytic mechanism that ensures the decomposition of polymer compounds contained in fuels into low molecular weight fragments that are easily subject to further oxidation. Such catalytic destruction of solid fuels occurs with low energy consumption, which is released in the form of additional heat, contributing to an increase in calorie content. This mechanism also ensures stability of the combustion process because the variability in energy costs for the decomposition of burned fuels is reduced, which makes the fuel more homogeneous.

Another positive aspect of the use of catalysts according to this invention is the significant reduction in the formation of toxic substances such as dioxins and polyaromatic hydrocarbons. This is accomplished by radically changing the mechanism of decomposition of solid and liquid fuels in the presence of catalysts, in accordance with this invention. In this case, practically no precursors of toxic substances are formed, and combustion is carried out in full without releasing substances toxic to the environment.

Catalysts, in accordance with the present invention, when added to liquid or solid fuels at concentrations from 0.001 to 0.1% by weight of the fuel, promote complete combustion of the fuel due to the low-temperature mechanism of decomposition of polymer compounds included in the fuel and subsequent complete oxidation of combustible components with oxygen air on catalytically active centers formed from the catalyst during its decomposition. This promotes complete combustion of fuels and a significant reduction in ash formation, which increases the energy efficiency of the combustion process and reduces the burden on the environment.

Thus, the catalysts in accordance with this invention act at all stages of the combustion process of solid and liquid fuels, which include both the decomposition of polymer compounds of solid and liquid fuels into flammable low-molecular fragments, and the catalysis of their subsequent complete oxidation by atmospheric oxygen.

Another important aspect of the use of fuel combustion catalysts in accordance with this invention is their low active concentration, which ranges from 0.001 to 0.1% by weight of the fuel. This is significantly less than the concentration of currently used catalysts, which averages from 1 to 5%, which significantly increases the ash content of burned fuels.

The advantage of the patented catalysts over their analogues is the effect on fuel at two successive oxidation stages. Polymer coordination compounds are used as catalysts, namely polymetallic, polymer coordination compounds with several metal atoms or several different metals in one molecule. Conventional low-molecular coordination compounds containing one metal atom do not have such activity. Polymer, polymetallic coordination compounds can be formed in three main ways.

Firstly, when there is a successive coordination, through a metal atom with a high coordination number, of several bi or polydentate ligands (not necessarily high-molecular), for example, triethanolamine. The second way is the formation of a metal-metal bond in a coordination compound. And the third way is the use of polymer ligands, for example, polyethylene polyamine or polyethylene oxide, when several metal atoms are attached to one molecule of a polymer ligand, which can also form a coordination bond with neighboring polymer ligands. Polymer coordination compounds are known, and some of them are described in the literature. But they have never been used as catalysts for the decomposition of high-molecular compounds in principle and in the combustion process in particular.

At the fuel heating stage, catalysts accelerate the process of low-temperature decomposition of polymeric fuel components to low-molecular components that are easily oxidized by atmospheric oxygen. At the fuel combustion stage, particles of catalyst decomposition products create catalytic oxidation centers that increase the efficiency of the combustion process.

The objects and advantages of the present invention will be more readily apparent from inspection of the following specification, taken in connection with the accompanying drawing, wherein like numerals refer to like parts throughout and in which an embodiment of the present invention is described and illustrated.

The exact manner in which the foregoing and other objects and advantages of the invention are achieved in practice will become more clearly apparent when reference is made to the following detailed description of the preferred embodiments of the invention described in detail in the following specification and shown in the accompanying drawings, where in like reference numbers indicate corresponding parts throughout.

### DETAILED DESCRIPTION OF THE INVENTION

Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

Additionally, as used herein, the singular forms “a,” “an,” and “the” include plural referents unless the context clearly dictates otherwise. Thus, for example, the term “module” is intended to mean one or more modules or a combination of modules. Furthermore, as used herein, the term “based on” includes based at least in part on. Thus, a feature that is described as based on some cause, can be based only on that cause, or based on that cause and on one or more other causes.

It will be apparent that multiple embodiments of this disclosure may be practiced without some or all of these specific details. In other instances, well-known process operations have not been described in detail in order not to unnecessarily obscure the present embodiments. The following description of embodiments includes references to the accompanying drawing. The drawing shows illustrations in accordance with example embodiments.

These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

The combustion process consists of several stages. It was found that in the initial stages, high-molecular-weight fuel compounds decompose into lower-molecular fragments, which subsequently undergo more efficient oxidation. This process occurs both with the participation of oxygen and without its participation due to the high-temperature thermal destruction of the fuel components. Most of the currently used catalysts work only for the combustion of solid and liquid fuels at the stage of oxidation with the participation of oxygen. In contrast to these solutions, the present invention operates both in the early stages without the participation of oxygen, by accelerating the thermal degradation of fuel components at high temperature. But the present invention also operates at the stage of oxidation. In this case, coordination compounds are transformed into catalytically active centers on which efficient and complete oxidation of combustion products occurs without side reactions and the formation of toxic combustion products.

This leads to a significant increase in the energy efficiency of the combustion process. In particular, when burning RDF, an increase was achieved in calorific value of 14.5% (Example 3). At the same time, the increase was in energy efficiency when burning hard coal equal to 15.5% (Example 6). This invention successfully solves the problem of both incomplete combustion of fuels and the formation of toxic combustion products that pollute the environment. In particular, when RDF is burned, a 3.57-fold reduction in the formation of toxic polychlorinated dibenzo-para-dioxins and polychlorinated dibenzofurans (PCDD/F) is achieved in accordance with Example 8.

The efficiency of catalysts in accordance with this invention does not depend on the type of fuel. For liquid fuels, a significant increase in energy efficiency has also been obtained. In particular, for heavy fuel oil samples, an increase was obtained in combustion energy efficiency of 11% in accordance with Example 10.

As presented in Example 1, the RDF sample was prepared in quantity 1 g and dried in oven at 60 degrees Celsius for 4 hours. Next, the RDF sample was burned in adiabatic calorimeter C2000 IKA, Germany for calorific value determination. It was obtained calorific value 14.154 MJ/kg.

As presented in Example 2, in the reaction flask, in ethanol, a portion of copper (II) nitrate hexahydrate was dissolved, then nickel (II) nitrate hexahydrate was added based on the molar ratio copper (II) nitrate hexahydrate/nickel (II) nitrate hexahydrate of 1/1.619. Then, cerium nitrate was added at the rate of 1.6 atomic percent with respect to the total content of copper and nickel atoms. After that, triethanolamine was added to the solution in a molar ratio of copper (II) nitrate hexahydrate/triethanolamine equal to 21/1 and kept for an hour to form a complex with catalytic properties.

As presented in Example 3, the catalyst solution obtained in Example 2 was diluted with ethanol to a concentration of 0.1% by weight. A sample of RDF weighing 1 g was prepared. The RDF sample was treated with resulting solution to obtain a final concentration of catalyst 0.01% by weight of RDF. The resulting modified RDF was dried in oven at 60 degrees Celsius for 4 hours for total ethanol removal. Next, the catalyst treated RDF sample was burned in adiabatic calorimeter N2000 IKA, Germany for calorific value determination. It was found that catalyst treated RDF has calorific value 16.206 MJ/kg that is 14.5% more in comparison with untreated RDF from Example 1.

As presented in Example 4, in the reaction flask, a weighed portion of chromium (III) nitrate nonahydrate was dissolved in water, then cerium (III) nitrate hexahydrate was added at the rate of 1.6 atomic percent with respect to chromium atoms. After that, polyethylene polyamine was dissolved in a molar ratio of chromium (III) nitrate nonahydrate/polyethylene polyamine equal to 34/1 and kept for an hour to form a complex. The amount of water was preselected to obtain a 15% solution of the final complex.

As presented in Example 5, the hard coal sample with weight equal to 0.9 g was prepared and dried in oven at 60 degrees Celsius for 6 hours. Next, the hard coal sample was burned in adiabatic calorimeter C2000 IKA, Germany for calorific value determination. It was obtained calorific value 34.632 MJ/kg.

As presented in Example 6, the catalyst solution obtained in Example 4 was diluted with distilled water to a concentration of 0.1% by weight. A sample of hard coal weighing 0.9 g was prepared. The hard coal sample was treated with resulting solution to obtain a final concentration of catalyst 0.01% by weight of hard coal. The resulting modified hard coal was dried in oven at 60 degrees Celsius for 6 hours. Next, the catalyst treated hard coal sample was burned in adiabatic calorimeter N2000 IKA, Germany for calorific value determination. It was found that catalyst treated hard coal has calorific value 39.999 MJ/kg that is 15.5% more in comparison with untreated hard coal from Example 5.

As presented in Example 7, prepared in quantity 10 g according to Example 1, RDF sample was burned in quartz tube with internal diameter 34 mm and with oxygen flow through the tube equal to 100 ml/min. Polychlorinated dibenzo-para-dioxins and polychlorinated dibenzofurans (PCDD/F) total amount was determined at the outlet of the tube. The quantity of PCDD/F was found as 7.5ng/m3.

As presented in Example 8, prepared in quantity 10 g according to Example 3, RDF sample was burned in quartz tube with internal diameter 34 mm and with oxygen flow through the tube equal to 100 ml/min. Polychlorinated dibenzo-para-dioxins and polychlorinated dibenzofurans (PCDD/F) total amount was determined at the outlet of the tube. The quantity of PCDD/F was found as 2.1 ng/m3 that is 3.57 times less that for RDF sample without burning catalyst treatment.

As presented in Example 9, the heavy fuel oil sample with weight equal to 0.8 g was prepared and dried in oven at 60 degrees Celsius for 6 hours. Next, the heavy fuel oil sample was burned in adiabatic calorimeter C2000 IKA, Germany for calorific value determination. It was obtained calorific value 39.452 MJ/kg.

As presented in Example 10, the catalyst solution obtained in Example 4 was diluted with distilled water to a concentration of 0.1% by weight. A sample of heavy fuel oil weighing 0.8 g was prepared. The heavy fuel oil sample was mixed with resulting solution to obtain a final concentration of catalyst 0.01% by weight of heavy fuel oil. The resulting modified heavy fuel oil was dried in oven at 60 degrees Celsius for 6 hours. Next, the catalyst treated heavy fuel oil sample was burned in adiabatic calorimeter N2000 IKA, Germany for calorific value determination. It was found that catalyst treated heavy fuel oil has calorific value 43.792 MJ/kg that is 11% more in comparison with untreated heavy fuel oil from Example 9.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof.

Therefore, it is intended that the invention not be limited to the particular embodiment disclosed as the best mode contemplated for carrying out this invention, but that the invention will include all embodiments falling within the scope of the appended claims.

1. (canceled)

2. (canceled)

3. (canceled)

4. (canceled)

5. (canceled)

6. (canceled)

7. A compound catalyst for enhancing the combustion efficiency of solid or liquid fuels, the catalyst comprising:
(a) at least one metal cation selected from transition metals, rare earth metals, alkali metals, alkaline earth metals, or combinations thereof;
(b) at least one ligand coordinated to the metal cation, the ligand being selected from organic ligands, inorganic ligands, or metal-containing ligands capable of forming coordination bonds with the metal cation; and
(c) at least one counter-anion selected from halides, nitrates, sulfates, phosphates, carboxylates. or complex organic anions; wherein the metal cation, ligand, and counter-anion form a charge-balanced coordination complex, and wherein the coordination complex is isolated in a form selected from a dry powder, a concentrate, or a solution of known concentration, independent of a solid zeolite carrier.

8. A method for preparing and applying the catalyst of claim to improve fuel combustion, comprising the steps of:
(a) combining one or more metal salts and one or more ligands in an aqueous or organic solvent to form the coordination complex;
(b) isolating the coordination complex as a dry powder, concentrate, or solution of known concentration; and
(c) directly applying the isolated coordination complex to a fuel selected from a solid fuel or a liquid fuel, wherein the coordination complex is applied without impregnation into a zeolite or porous inorganic support.

9. The method as set forth in 8, wherein the coordination complex is dried into powder form and combined with a thermally degradable polymer to form a solid carrier composition.

10. The method as set forth in 8, wherein the catalyst solution is sprayed onto the solid fuel and dried at ambient or elevated temperature to form a catalytic coating.

11. The method as set forth in 8, wherein the catalyst is mixed into a molten fuel formulation and allowed to solidify prior to combustion.

12. The method as set forth in claim 8, wherein the reaction medium comprises an aqueous or organic solvent and the reaction temperature ranges from 20° C. to 100° C.
